(19) United States
(12) Patent Application Publication
(10) Pub. No.: US 2015/0355630 A1
(43) Pub. Date: Dec. 10, 2015

(54) UNIFIED CONTROL OF AN ELECTRONIC CONTROL SYSTEM AND A FACILITY CONTROL SYSTEM

(71) Applicant: HEWLETT-PACKARD DEVELOPMENT COMPANY, L.P., Houston, TX (US)

(72) Inventors: Tahir Cader, Liberty Lake, WA (US); Nilashis Dey, Houston, TX (US); Royal H King, Magnolia, TX (US); John P Franz, Houston, TX (US); Michael L Sabotta, Houston, TX (US); Gardson Githu, El Segundo, CA (US); Douglas Kent Garday, Mesa, AZ (US); Peter Hansen, Cypress, TX (US); Sammy Lee Zimmerman, Sr., Houston, TX (US)

(21) Appl. No.: 14/763,504

(22) PCT Filed: Jan. 30, 2013
(86) PCT No.: PCT/US2013/023932

§ 371 Date: Jul. 24, 2015

(51) Int. Cl. G05B 19/408; G05B 19/414

(52) U.S. Cl. CPC G05B 19/408; G05B 19/414; G05B 2219/31406

(57) ABSTRACT

A control apparatus is provided. The control apparatus includes an electronic engine, a facility engine, and a control engine. The electronic engine to communicate with an electronic control system. The facility engine to communicate with a facility control system. The control engine to provide an interface between the electronic engine and the facility engine to unify control of the electronic control system and the facility control system.

### BACKGROUND

A data center is typically controlled independently of the controls of a building or facility in which the electronic components that form the data center are housed.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 illustrates a block diagram of a system to unify control of an electronic control system and a facility control system according to an example;

FIGS. 2-3 illustrate block diagrams of the system of FIG. 1 according to examples;

FIGS. 4-5 illustrate block diagrams of a control apparatus according to examples;

FIG. 6 illustrates a schematic diagram of the system of FIG. 1 according to an example;

FIG. 7 illustrates a flow chart of a method to unify control of an electronic system and a facility control system according to an example; and

FIG. 8 illustrates a schematic diagram of a facility usable with the system, method, and control apparatus of FIGS. 1-7 according to an example.

### DETAILED DESCRIPTION

In the following detailed description, reference is made to the accompanying drawings which form a part hereof, and in which is depicted by way of illustration specific examples in which the present disclosure may be practiced. It is to be understood that other examples may be utilized and structural or logical changes may be made without departing from the scope of the present disclosure.

The controls that manage servers in a datacenter are typically isolated from the controls of a building or facility in which the servers are housed. Independent management of data centers and facilities makes it difficult to optimize efficiency of both the data center and the facility. For example, little or no communication and coordination exists between a data center control system and a facility control system. This can be detrimental to both the data center and the facility when an event occurs that hinders performance of one or the other, such as a power failure or a fluid leak.

In examples, a control apparatus is provided. The control apparatus includes an electronic engine, a facility engine, and a control engine. The electronic engine to communicate with an electronic control system. The facility engine to communicate with a facility control system. The control engine to provide an interface between the electronic engine and the facility engine to unify control of the electronic control system and the facility control system. The unified control enables communication and coordination between the electronic control system and the facility control system.

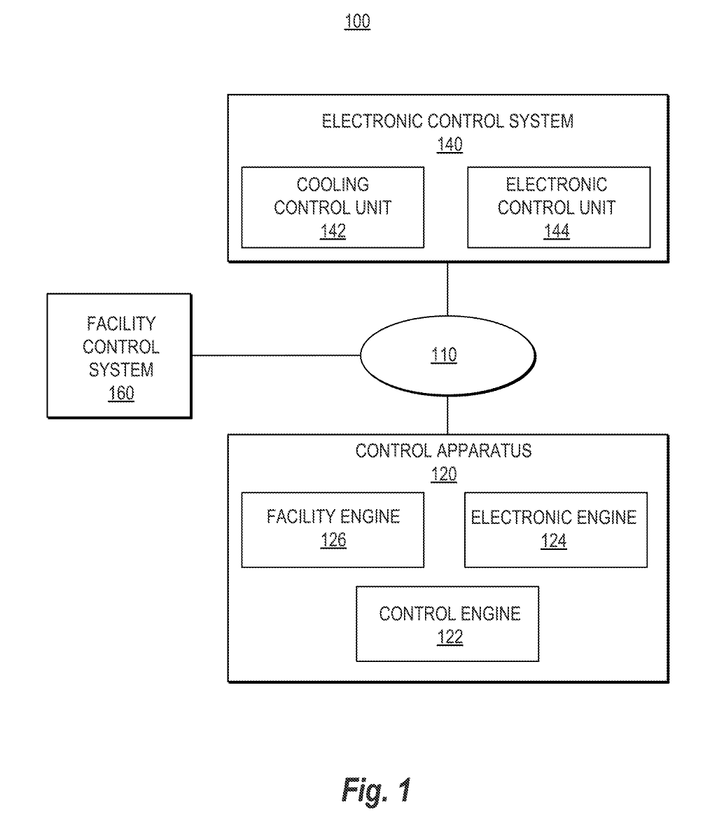

FIG. 1 illustrates block diagram of a system 100 to unify control of a data center and a facility according to an example. The system includes the control apparatus 120, the electronic control system 140, and the facility control system 160. The control apparatus 120 includes a control engine 122, an electronic engine 124, and a facility engine 126. The control engine 122, the electronics engine 124, and the facility engine 126 to interface with one another to unify control of a data center and a facility that includes the data center. The electronic engine 124 to interface with the electronic control system 140. The facility engine 126 to interface with the facility control system 160. The control engine 122 to provide an interface between the electronic engine 124 and the facility engine 126 to unify control of the electronic control system 140 and the facility control system 160.

Referring to FIG. 1 the electronic control system 140 manages a data center. For example, the electronic control system 140 includes a cooling control unit 142 to control a set of cooling components and an electronic control unit 144 to control a set of electronic components. For example, the set of cooling components include at least one data center cooling component and at least one rack cooling component. Similarly, the set of electronic components include at least one data center electronic component and at least one rack electronic component.

The facility control system 160 manages a facility that includes or houses the data center. For example, the facility control system 160 manages the power, heating, cooling, and/or water of at least one building or facility.

The system 100 uses a control apparatus 120 to unify control of an electronic control system 140 and a facility control system 160. The control apparatus 120 is linked to the electronic control system 140 and the facility control system 160. For example, the control apparatus 120 may be connected to the electronic control system 140 and the facility control system 160 via a link 110. The link 110 represents generally one or more of a cable, wireless, fiber optic, and/or remote connections via a telecommunication link, an infrared link, a radio frequency link, or any other connectors or systems that provide electronic communication. The link 110 includes, at least in part, an intranet, the Internet, or a combination of both. The link 110 may also include intermediate proxies, routers, switches, load balancers, and the like.

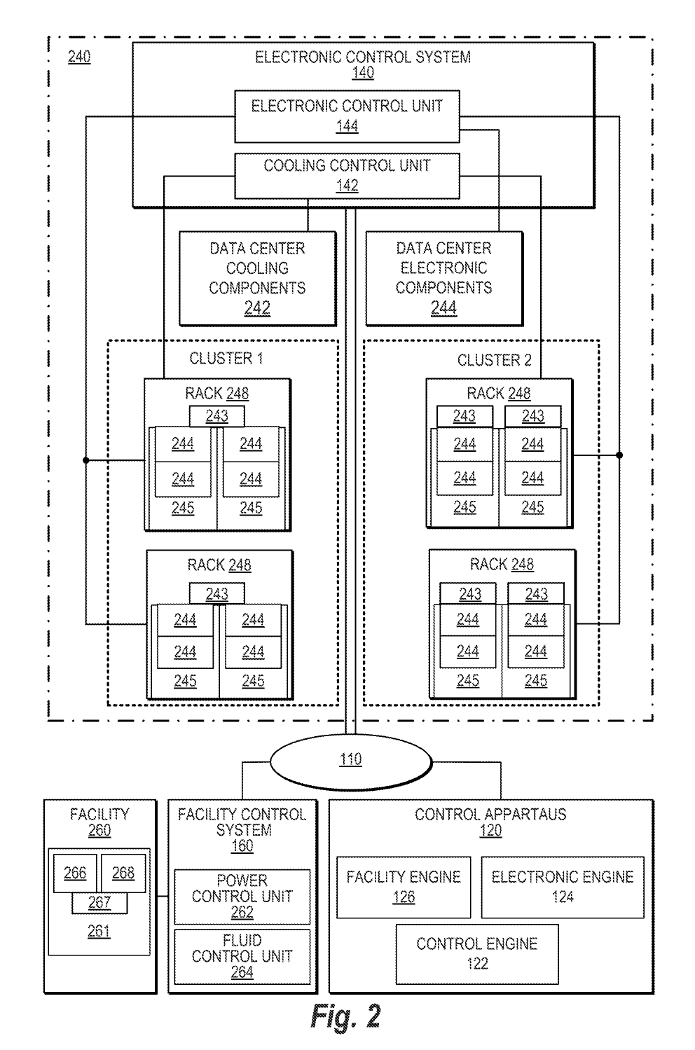

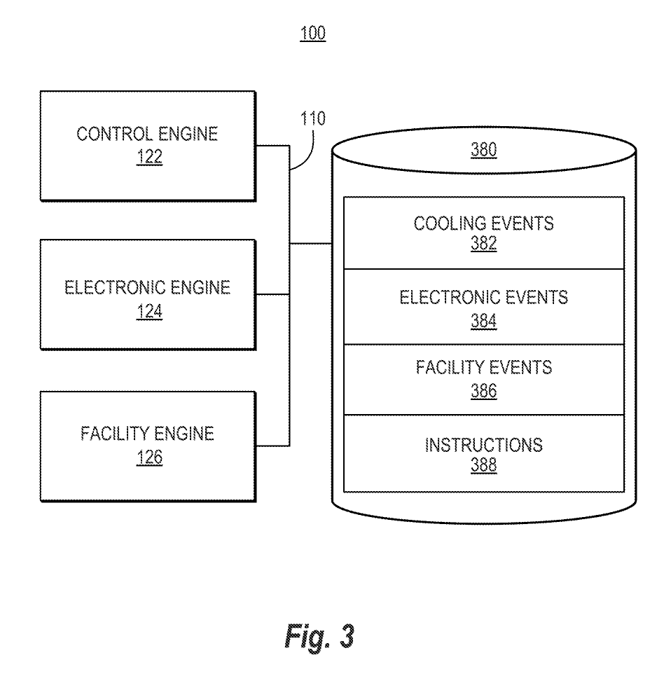

FIGS. 2-3 illustrate the system 100 of FIG. 1 according to examples. Referring to FIG. 2, a further example of the system 100 is illustrated. The system 100 includes the control apparatus 120, the electronic control system 140, the data center 240 managed by the electronic control system 140, the facility control system 160, and the facility 260 controlled by the facility control system 160.

The electronic control system 140 controls the functioning and management of the electronic devices, illustrated in cluster 1 and cluster 2. The electronic control system 140 includes the cooling control unit 142 and the electronic control unit 144. The cooling control unit 142 controls or manages a set of cooling components that cool or control the temperature of the electronics components in the computer module 246 and/or the rack 248. The set of cooling components include at least one data center cooling component 242 and at least one rack cooling component 243. For example, the at least one data center cooling component 242 may include a heat exchanger, a pump, a vacuum pump, a leak detector, a sensor, and/or electromechanical valves. The at least one rack cooling component 243 may include a heat sink, a fan, a pump, an electromechanical valve, and a leak detector. The rack cooling components 243 in each rack 248 may be shared by multiple computer modules 246, as illustrated in cluster 1 and/or each may be associated with a single computer module 246, as illustrated in cluster 2.

In an example, the at least one data center cooling component 242 receives a fluid, such as water, from the facility and sets the temperature and/or the pressure of the water as controlled by the cooling control unit 142. The at least one data center cooling component 242 may form a coolant distribution unit that distributes the fluid to the rack 248. For example, a liquid to liquid heat exchanger may be used to set the temperature of the liquid and the temperature may be measured using a sensor or thermometer. Once the temperature is set the liquid is distributed to the racks 248 using the pump, vacuum pump, and/or electromechanical valves.

At the rack 248 level, the fluid may be used for liquid cooling and the cooling control unit 142 may control the cooling process. The at least one rack cooling component 243 cools the electronic components 245 in the rack and maintains the temperature and/or pressure within the rack 248 using the heat sink, fan, pump, and/or electromechanical valve. Both the at least one data center cooling component 242 and the at least one rack cooling component 243 may also be equipped to continually monitor the components using sensors that monitor the temperature and/or pressure and/a leak detector that identifies leaks or problems within the systems normal thresholds.

The set of cooling components may form a cooling system. Each cooling system may work independently and/or in combination to manage cooling of the data center 240, at least one rack 248, and/or a compute module 246 formed of the set of electronic components. For example, the data center 240 is illustrated as including two clusters, cluster 1 and cluster 2. Each cluster is connected to the cooling control unit 142. One cooling system may manage a single rack 248, one computer module 246, or a cluster with two racks 248 as illustrated in FIG. 2, but more racks 248, and/or clusters may also be connected to form the cooling systems.

The electronic control unit 144 controls a set of electronic components, such as the at least one data center electronic component 244 and the at least one rack electronic component 245. For example, the at least one data center electronic component 244 may include a power supply that receives power from the facility and uses a power distribution unit to distribute the power within the data center 240, such as to a cluster of racks 248, to individual racks 248, and/or computer modules 246.

The at least one rack electronic component 245 may include a power supply, a compute module, a circuit board, memory, and PCI-E cards. For example, each rack 248 may include an uninterruptible power supply (UPS) that manages power to the racks 248. As FIG. 2 illustrates, the at least one rack electronic component 245 may form part of the compute modules 246 that are disposed on the rack 248, such that, each compute module 246 includes a plurality of rack electronic components 245. Each rack 248 may also include a plurality of compute modules 246. For example the compute module 246 may include one or more servers in a rack 248. The servers or compute modules 246 may include racks 248 that provide computer solutions, storage solutions, network solutions, and/or cloud services.

The electronic control system 140 is illustrated within the data center 240, but may be connected to the data center 240 via a remote connection. Moreover, the cooling control unit 142 and the electronic control unit 144 each represent functionalities that may be performed using at least one control unit that may work alone or in combination with other control units. The cooling control unit 142 and the electronic control unit 144 may also each represent a plurality of control units working in combination to perform the specified functions.

The system 100 further includes a facility 260 that includes or houses the data center 240. The facility 260 includes facility components 261, such as facility power components 266 that control the power within the facility 260, facility temperature components 267, and/or facility fluid components 268 that control fluid within the facility 260. For example, the facility control system 160 controls the operation of the facility 260, using a variety of the facility components 261, such as chillers, cooling towers, computer room air handlers (CRAHs), humidification/dehumidification systems, blowers, pumps, valves and/or other mechanical or electronic units that are used to maintain the facility.

As illustrated in FIG. 2, the facility control system 160 includes a power control unit 262, and a fluid control unit 264 that control the facility components 261. The power control unit 262 manages the power supplied to the facility and controls shutting off the power or transitioning between power systems using at least one power component 266. For example, the power control unit 262 controls power supplied to the data center 240. The power is then controlled within the data center 240 via the electronic control system 140 as discussed above. The fluid control unit 264 controls fluid, such as water or oil that is supplied to the facility 260 using fluid pumps to distribute the fluid and fluid valves to control the flow of the fluid. The valves may be capable of being set to various settings.

The control apparatus 120 unifies control of the electronic control system 140 and the facility control system 160. The control apparatus 120 includes a control engine 122, an electronic engine 124, and a facility engine 126.

The electronic engine 124 represents generally a combination of hardware and/or programming that interfaces with the electronic control system 140. For example, the electronic engine 124 facilitates communication and/or a connection with the electronic control system 140. The electronic engine 124 gathers data from the electronic control system 140, such as functionality information about the electronic components, functionality information about the cooling components, temperature monitors, and leak detectors.

The facility engine 126 represents generally a combination of hardware and/or programming that communicates with the facility control system 160. For example, the facility engine 126 facilitates communication and/or a connection with the facility control system 160. The facility engine 126 gathers data from the facility control system 160, such as, data from the power control unit 262, power supply monitors, a fluid control unit 264, and/or main valve monitors for the facility.

The control engine 122 represents generally a combination of hardware and/or programming that provides an interface between an electronic engine 124 and the facility engine 126 to unify control of the electronic control system 140 and the facility control system 160. For example, the control engine 122 communicates with the electronic engine 124 and the facility engine 126. The control engine 122 communicates with the electronic engine 124 to gather data related to management of the data center 240. The control engine 122 communicates with the facility engine 126 to gather data related to control of the facility that includes or houses the data center 240.

Referring to FIG. 3, a portion of the system 100 of FIG. 1 is illustrated. The system 100 is illustrated includes a control engine 122, an electronic engine 124, and a facility engine 126 that are part of a control apparatus 120 that is linked 110 to the electronic control system 140 and the facility control system 160, as illustrated in FIGS. 1-2. The system 100 is further illustrated to include a data store 380 connected to the control engine 122, the electronic engine 124, and the facility engine 126 via the link 110. The control engine 122 functionalities are accomplished via the link 110 that connects the control engine 122 to the electronic engine 124, the facility engine 126, and the data store 380.

The data store 380 represents generally any memory configured to store data accessible by the control engine 122, the electronic engine 124, and/or the facility engine 126 in the performance of its function. The data store 380 is, for example, a database that stores cooling events 382, electronic events 384, facility events 386, and instructions 388 to perform the functions of the control engine 122, the electronic engine 124, and the facility engine 126.

The cooling event 382 is, for example, a warning or response to a variation in functioning of the data center or rack cooling component(s) 242, 243 and identified by the cooling control unit 142. The cooling event 382 is received by the electronic engine 124 and depending on the cooling event 382, selectively triggers a transmission of a message from the facility engine 126 to the facility control system 160. The message corresponds to a response to the cooling event 382. The message may include a message to an operator, a signal sent to automatically correct or mitigate the problem or providing a notification of the event via, for example, lights or a user interface.

The electronic event 384 is, for example, a warning or response to the functioning or malfunctioning of the data center or rack electronic component(s) 244, 245 and identified by the electronic control unit 144. The electronic event 384 is received by the electronic engine 124 and depending on the electronic event 384, selectively triggers a transmission of a message from the facility engine 126 to the facility control system 160. The message corresponds to a response to the electronic event 384. The message may include a message to an operator, a signal sent to automatically correct or mitigate the problem, or a notification of the event via, for example, lights or a user interface.

The facility event 386 is, for example, a warning or response to the functioning or malfunctioning of one of the facility components 261, such as the power component 266 or the fluid component 268. The facility control unit 262 identifies the event. The facility engine 126 receives the facility event 386 and depending on the facility event 386, selectively triggers a transmission of a message from the electronic engine 124 to the electronic control system 140. The message corresponds to a response to the facility event 386. The message may include a message to an operator, a signal sent to automatically correct or mitigate the problem, or a notification of the event via, for example, lights or a user interface.

The control apparatus 120 determines or identifies the appropriate event signals, response, and/or messages for the data gathered from the electronic engine 124 and the facility engine 126. The control apparatus 120 uses the data gathered to provide a unified response and prevent or mitigate damage to the system 100. The control apparatus 120 may include additional functionalities, such as the ability to generate notifications of the events, via for example, a notification engine (not illustrated) that represents generally a combination of hardware and/or programming that generates a notification based on at least one of a cooling event 382, an electronic event 384, and a facility event 386. The notification engine may be a separate engine or incorporated into at least one of the control engine 122, the electronic engine 124, and the facility engine 126 that may individually or in combination perform the functions that generate the notification.

The notification may be used to allow manual actions, such as a soft shutdown of a data center 240. The soft shut down, may be performed manually or automatically and to prevent loss of data or abrupt disruption of service. Other action includes transitioning between one or more clusters or temporarily making changes in the data center 240 to prevent damage or disruption of service due to the event.

The notification may also be used as a “last resort” as the control apparatus 120 determines that there is a problem and the notification provides users with a reason for a service disruption or a reference to the event for trouble shooting. The notification may alternatively be a reporting process to monitor and record the cooling events 382, the electronic events 384, and/or the facility events 386.

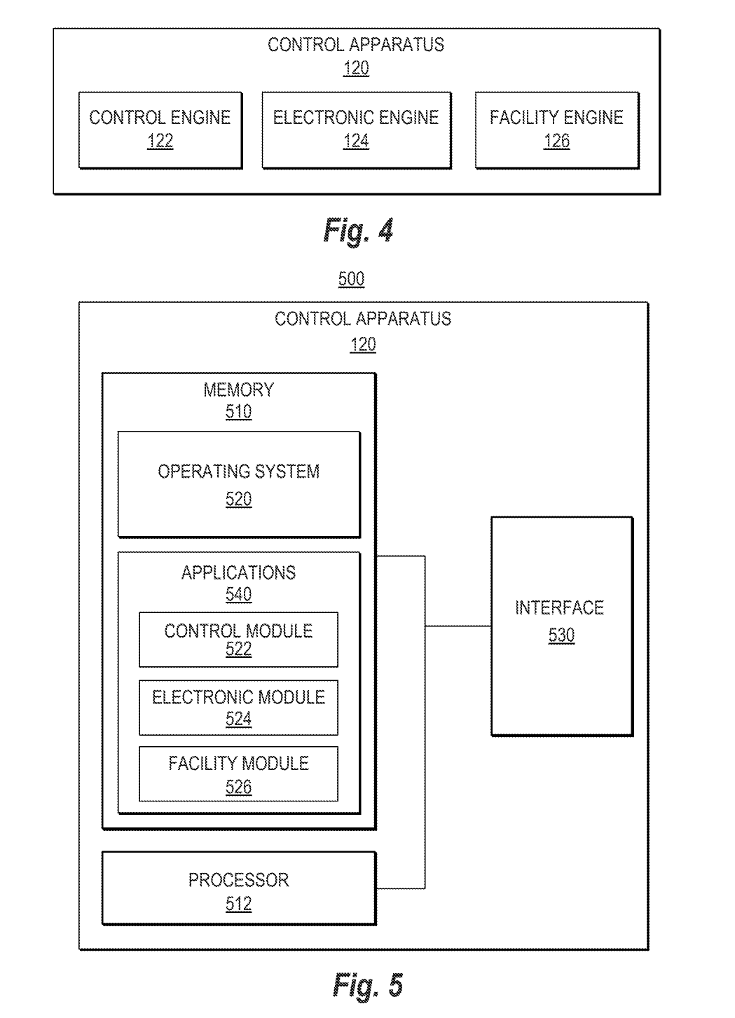

FIG. 4 illustrates a control apparatus 120 according to an example. The control apparatus 120 includes an electronic engine 124, a facility engine 126, and a control engine 122. The electronic engine 124 to receive data from an electronic control system 140. The electronic control system 140 to manage a set of cooling components and a set of electronic components.

The electronic control unit 144 to control a set of electronic components, such as the at least one data center electronic component 244 and the at least one rack electronic component 245. For example, the at least one data center electronic component 244 may include a power supply that receives power from the facility and uses a power distribution unit to distribute the power within the data center 240, such as to a cluster of racks 248, to individual racks 248, and/or computer modules 246. The at least one rack electronic component 245 may include a power supply, a compute module, a circuit board, memory, and PCI-E cards. For example, each rack 248 may include an uninterruptible power supply (UPS) that manages power to the racks 248. For example, the at least one rack electronic component 245 included is part of a compute module 246 in a rack 248, as illustrated in FIG. 2.

The set of cooling components to manage or control the temperature or cooling of the at least one electronic components. The set of cooling components include at least one data center cooling component 242 and at least one rack cooling component 243. The at least one data center cooling component 242 to control the temperature of the data center 240 and/or fluid pressure or temperature to be used by the at least one rack cooling components 243. For example, the at least one data center cooling component 242 may include a heat exchanger, a pump, a vacuum pump, a leak detector, a sensor, and/or electromechanical valves. The at least one rack cooling component 243 control or manage the temperature of the rack electronic components 245 and/or the fluid used therewith. The at least one rack cooling component 243 may include a heat sink, a fan, a pump, an electromechanical valve, and a leak detector.

The facility engine 126 to receive data from a facility control system 160. The facility control system 160 manages a facility that includes a set of electronic components and a set of cooling components, such as a data center 240 as illustrated in FIG. 2. The facility may include a control room with facility components 262, such as

chillers, cooling towers, computer room air handlers (CRAHs), humidification/dehumidification systems, blowers, pumps, valves and/or other mechanical or electronic units that are used to maintain the facility.

The control engine 122 to provide an interface between the electronic engine 124 and the facility engine 126 to unify control of the electronic control system 140 and the facility control system 160. For example, the control engine 122 receives a cooling event 382 or an electronic event 384 from the electronic engine 124 and provides the cooling event 382 or the electronic event 384 to the facility engine 126. The facility engine 126 transmits a message to the facility control system 160 in response to the cooling event 382 or the electronic event. The cooling event 382 includes data relating to the cooling components, such as power for the cooling system, operation of a fan, and/or a fluid control mechanism. The electronic event 384 includes data relating to the data center 240 and rack electronic components 244, 245, such as power for the electronic components or a system failure or error. In a further example, the control engine 122 receives a facility event 386 from the facility engine 126 and provides the facility event 386 to the electronic engine 124. The electronic engine 124 transmits a message to the electronic control system 140 in response to the facility event 386, for example data relating to the facility components 261.

Referring to FIG. 5, the control apparatus 120, for example, includes firmware or a computer readable medium 500 that interfaces an electronic control system 140 and a facility control system 160. In FIG. 5, the control apparatus 120 is illustrated to include a memory 510, a processor 512, and an interface 530. The memory 510 stores a set of instructions. The processor 512 is coupled to the memory 510 to execute the set of instructions. The processor 512 represents generally any processor configured to execute program instructions stored in memory 510 to perform various specified functions. The interface 530 represents generally any interface enabling the control apparatus 120 to communicate with the control engine 122, the electronic engine 124, the facility engine 126, and/or the data store 380 via the link 110, as illustrated in FIGS. 1-3.

The memory 510 is illustrated to include an operating system 540 and applications 550. The operating system 540 represents a collection of programs that when executed by the processor 512 serves as a platform on which applications 550 run. Examples of operating systems 540 include various versions of Microsoft's Windows® and Linux®. Applications 550 represent program instructions that when executed by the processor 512 function as an application that when executed by a processor 512 unify control of the electronic control system 140 and the facility control system 160.

For example, FIG. 5 illustrates a control module 522, an electronic module 524, and a facility module 526 as executable program instructions stored in memory 510 of the control apparatus 120. The control module 522, when executed provides an interface between the electronic engine 124 and the facility engine 126 to unify control of the electronic control system 140 and the facility control system 160. For example, the set of instructions enable the control engine 122 to control communication between the electronic engine 124 and the facility engine 126.

In an example, the control engine 122 receives data from the electronic engine 124 and identifies a cooling event 382 and/or an electronic event 384. The control engine 122 provides the cooling event 382 or the electronic event 384 to the facility engine 126. In response, the facility engine 126 transmits a message to the facility control system 160.

In a further example, the control engine 122 receives data from the facility engine 126 and identifies a facility event 386. The control engine 122 provides the facility event 386 to the electronic engine 124. In response, the electronic engine 124 transmits a message to the electronic control system 140. The facility event 386 may include, for example, a power failure, an uninterruptible power supply (UPS) failure, a system failure event, a pump failure, a chiller failure, and/or malfunctioning of a heating or cooling unit.

The electronic module 524, when executed receives data from the electronic control system 140. For example, the electronic module 524 receives data that identifies a cooling event 382 from a cooling control unit 142 and/or an electronic event 384 from an electronic control unit 144. The facility module 526, when executed receives data from the facility control system 160. For example, the facility module 526 receives data that identifies a facility event 386 from a facility control unit 146.

The set of instructions 388 facilitate the transmission of data to, from, and between the control module 522, the electronic control module 524, and the facility control module 526. For example, the set of instructions 388 are executed to send and receive data between the electronic module 524 and the electronic control system 140 and between the facility module 526 and the facility control system 160 in order to collect and share data via the control module 522. In an example, the control module 522 may analyze the data and based on data determine or identify events, transmit a message that indicates an event occurring and/or actions to remedy or mitigate the event. The control module 522 via the message provides communication between the electronic control system 140 and the facility control system 160.

Referring back to FIGS. 1-3, the control engine 122, the electronic engine 124, and the facility engine 126 of the control apparatus 120 are described as combinations of hardware and/or programming. As illustrated in FIG. 5, the hardware portions include the processor 512. The programming portions include the operating system 540, applications 550, and/or combinations thereof. For example, the control module 522 represents program instructions 388 that when executed by a processor 512 cause the implementation of the of the control engine 122 of FIGS. 1-3. The electronic module 524 represents program instructions 388 that when executed by a processor 512 cause the implementation of the electronic engine 124 of FIGS. 1-3. The facility module 526 represents program instructions 388 that when executed by a processor 512 cause the implementation of the facility engine 126 of FIGS. 1-3.

The programming of the control module 522, electronic module 524, and facility module 526 may be processor 512 executable instructions stored on a memory 510 that includes a tangible memory media and the hardware includes a processor 512 to execute the instructions. The memory 510 may store program instructions that when executed by the processor 512 cause the processor 512 to perform the program instructions. The memory 510 is integrated in the same device (or system) as the processor 512 or it is separate but accessible to that device (or system) and processor 512.

In some examples, the program instructions may be part of an installation package that can be executed by the processor 512 to perform a method using the system 100. The memory 510 is a portable medium such as a CD, DVD, or flash drive or a memory maintained by a server from which the installation package can be downloaded and installed. In some examples, the program instructions may be part of an application or applications already installed on a computing device. In further examples, the memory 510 includes integrated memory, such as a hard drive.

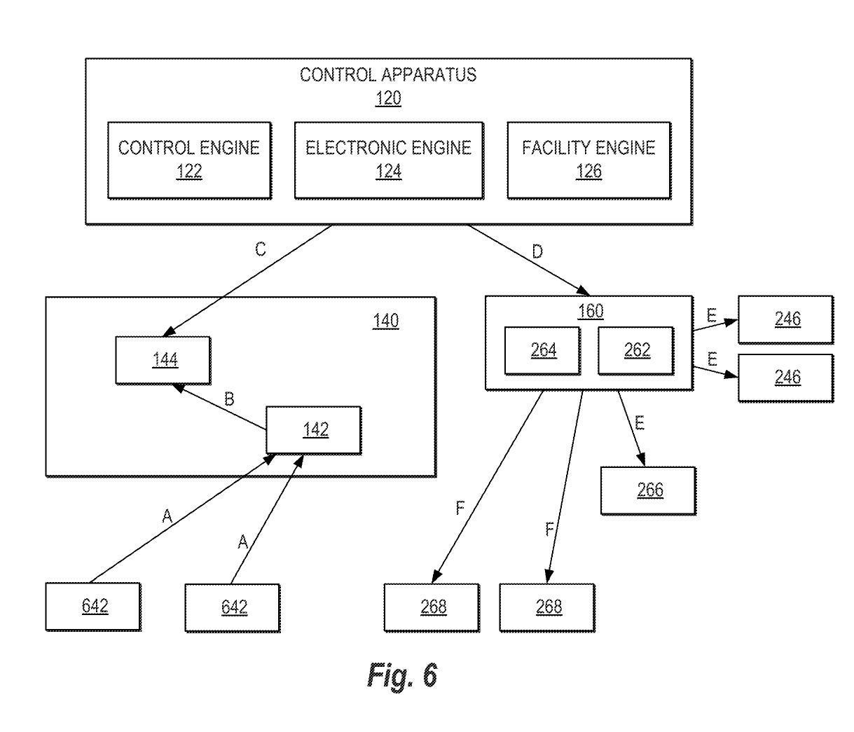

FIG. 6 illustrates a schematic diagram of the system of FIG. 1 according to an example. The example illustrates the advantages of a system with a control apparatus 120 to automate at least one of the following: leak detection and mitigating action to prevent or reduce damage to the customer's data center 240 and the facility 260; cluster power-up and power down sequences; cooling system failover; warm water generation; and vacuum controls.

Referring to FIG. 6, the system 100 includes a control apparatus 120, an electronic control system 140, and a facility control system 160. The control apparatus 120 includes an electronic engine 124 to interface with the electronic control system 140. A facility engine 126 to interface with the facility control system 160. A control engine 122 to provide an interface between the electronic engine 124 and the facility engine 126 to unify control of the electronic control system 140 and the facility control system 160. The electronic control system 140 manages a data center 240 (not illustrated). The facility control system 160 manages a facility 260 (not illustrated) that includes the data center 240.

FIG. 6 illustrates a sequence that uses the control apparatus 120 to cut power to the facility control system 160 that supplies power to at least a portion of a data center 240 when a leak is detected by the electronic control system 140. The leak is detected by a cooling component, such as a leak detector 642. FIG. 6 illustrates two leak detectors, for example, one in the upper portion of a rack 248 and one in a lower portion of the rack 248. The leak detectors 642 are designed to indicate a leak based on pre-defined thresholds that qualify as a significant leak. The leak detectors 642 notify (A) a cooling control unit 142, which notifies (B) the electronic control unit 144 within the electronic control system 140. The electronic control system 140 notifies (C) the control apparatus 120 via the electronic engine 124 that receives data relating to the leak.

The control apparatus 120 (D) notifies the facility control system 160. The facility control system 160 cuts power (E) to at least a portion of the data center 240, such as a power distribution unit that controls power to an entire data center 240, at least one cluster, at least one rack 248, and/or at least one electronic component therein. For example, the facility control system 160 uses a power control unit 262 to cut power to facility components 261, such as power supplies that provide power to the data center 240. The facility control system 160 may also use the fluid control unit 264 to close (F) electromechanical valves that supply fluid, such as water or oil, to the data center 240. Alternatively, the cooling control unit 142 may close valves associated with a cooling distribution unit and the cooling control unit 142 and/or the electronic control unit 144 may close valves associated with the racks 248.

The control apparatus' 120 communication with the electronic control system 140 and the facility control system 160 and response to the leak stops the supply of power and/or fluid to the data center 240, or portion of the data center 240 with the leak. The control apparatus 120 alone or in combination with the electronic control system 140 and the facility control system 160 identify and determine the actions needed to respond to the leak. The response may be a combination of automatic or manual actions that prevent and/or mitigate any damage resulting from the leak. The actions may depend on the type of event, i.e., a leak in this example.

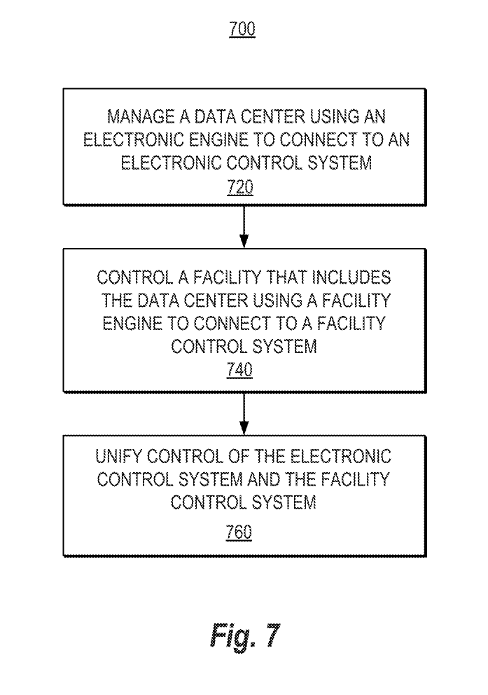

FIG. 7 illustrates a flow chart 700 of a method to interface an electronic control system and a facility control system according to an example. The method manages a data center in block 720. The data center is managed using an electronic engine to connect to the electronic control system. In block 740, a facility that includes the data center is controlled using a facility engine to connect to the facility control system. The control of the electronic control system and the facility control system is unified in block 760. The unification is performed using a control engine to provide an interface between the electronic engine and the facility engine. For example, the control engine may be part of a control apparatus used to unify control of an electronic system and a facility control system.

Although the flow diagram of FIG. 7 illustrates specific orders of execution, the order of execution may differ from that which is illustrated. For example, the order of execution of the blocks may be scrambled relative to the order shown. Also, the blocks shown in succession may be executed concurrently or with partial concurrence. All such variations are within the scope of the present invention.

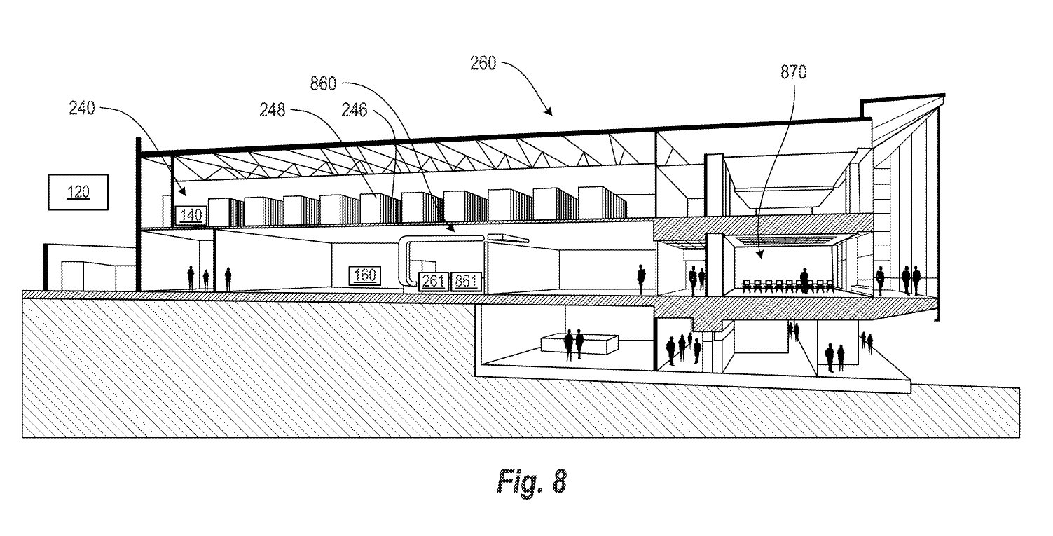

FIG. 8 illustrates an example of a facility 260 usable with the system 100, method 700, and control apparatus 120 of FIGS. 1-7 according to an example. The facility 260 includes a room, such as a control room 860 that contains the facility components 261 to be controlled or managed by the facility control system 160. The control room 860 creates a primary loop that provides, for example, power and fluid to the facility 260. The control apparatus 120 enables the primary loop to manage power and fluid to the data center 240 in a controlled manner. For example, the data center 240 may have a secondary loop that manages cooling using fluid, i.e., creating a water loop. The communication or management of the entire system using the control apparatus 120 enables the primary loop to create a vacuum that could reduce the risk of fluid leaking and instead make it more likely that the only leakage would be air, in the case where the water loop has a leak.

The facility 260 also includes a room that houses a data center 240 that has racks 248 of servers and/or compute modules 246 disposed therein. The data center 240 may be equipped to regulate the temperature and power supplied thereto using the electronic control system 140. The data center 240 illustrated also uses a liquid cooling system that uses heat pipes to remove the heat from the racks 248, removes the heat from the heat pipes using liquid that receives the heat from the heat pipes. The liquid that is heated is removed from the data center 240. For example the liquid is sent to the control room 860. The fluid may then be recycled and used to heat an adjacent room 870. Alternatively the heat removed from the data center 240 may be cooled using a heat exchanger 861 in the control room 860 and recycled back into the data center 240 and used to repeat the cycle of cooling the racks 248.

The present disclosure has been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be exemplary. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. A control apparatus comprising:
an electronic engine to communicate with an electronic control system;
a facility engine to communicate with a facility control system; and
a control engine to provide an interface between the electronic engine and the facility engine to unify control of the electronic control system and the facility control system.

2. The apparatus of claim 1, wherein the electronic control system manages a set of electronic components and a set of cooling components.

3. The apparatus of claim 1, wherein the facility control system manages a facility that includes the set of electronic components.

4. The apparatus of claim 1, wherein the control engine receives data identifying an electronic event from the electronic engine and provides the electronic event to the facility engine, the facility engine transmits a message to the facility control system in response to the electronic event.

5. The apparatus of claim 1, wherein the control engine receives data identifying a cooling event from the electronic engine and provides the cooling event to the facility engine, the facility engine transmits a message to the facility control system in response to the cooling event.

6. The apparatus of claim 1, wherein the control engine receives data identifying a facility event from the facility engine and provides the facility event to the electronic engine, the electronic engine transmits a message to the electronic control system in response to the facility event.

7. A system to unify control of an electronic control system and a facility control system, the system comprising:
an electronic control system to manage a data center;
a facility control system to manage a facility that includes the data center; and
a control apparatus including:
an electronic engine to interface with the electronic control system;
a facility engine to interface with the facility control system; and
a control engine to provide an interface between the electronic engine and the facility engine to unify control of the electronic control system and the facility control system.

8. The system of claim 7, wherein the electronic control system further comprises an electronic control unit to control a set of electronic components.

9. The system of claim 8, wherein the electronic control system further comprises a cooling control unit to manage cooling the set of electronic components, the cooling control unit uses a set of cooling components.

10. The system of claim 9, wherein the cooling control unit manages cooling components for a plurality of server racks.

11. The system of claim 7, wherein the control engine receives data identifying an electronic event from the electronic engine and provides the electronic event to the facility engine, the facility engine transmits a message to the facility control system in response to the electronic event.

12. The system of claim 7, wherein the control engine receives data identifying a cooling event from the electronic engine and provides the cooling event to the facility engine, the facility engine transmits a message to the facility control system in response to the cooling event.

13. The system of claim 7, wherein the control engine receives data identifying a facility event from the facility engine and provides the facility event to the electronic engine, the electronic engine transmits a message to the electronic control system in response to the facility event.

14. The system of claim 7, wherein the facility control system further comprises:
a power control unit to control power managed by the electronic control system, and
a fluid control unit to control fluids managed by the electronic control system.

15. A method to interface an electronic control system and a facility control system, the method comprising:
managing a data center using an electronic engine to connect to the electronic control system;
controlling a facility that includes the data center using a facility engine to connect to the facility control system; and
unifying control of the electronic control system and the facility control system using a control engine to provide an interface between the electronic engine and the facility engine.
